(19) United States
(12) Patent Application Publication
(10) Pub. No.: US 2026/0094606 A1
(43) Pub. Date: Apr. 2, 2026

(54) HYBRID CONVERSATIONAL AI SYSTEM

(71) Applicant: INTERNATIONAL BUSINESS MACHINES CORPORATION, Armonk, NY (US)

(72) Inventors: Gennaro Anthony Cuomo, Raleigh, NC (US); Robert Leslie Yates, Arlington, MA (US); Haechul Shin, Durham, NC (US); Blaine H. Dolph, Western Springs, IL (US)

(21) Appl. No.: 18/903,848

(22) Filed: Oct. 1, 2024

(51) Int. Cl. G10L 15/22; G10L 15/28

(52) U.S. Cl. CPC G10L 15/22; G10L 15/28

(57) ABSTRACT

A computer hardware system includes a hybrid router/manager, a generative artificial intelligence (AI) conversational agent, a rule-based AI conversational agent, and a content store. A present query is received from a client device associated with a user. The hybrid router/manager selects between the generative AI conversational agent and the rule-based AI conversational agent based upon a query analysis of the present query. The hybrid router/manager, based upon the query analysis, routes the present query to a selected one of the generative AI conversational agent and the rule-based AI conversational agent. The selected one of the conversational agents generates a response to the present query, and the response is forwarded to the client device. A feedback analysis associated with the response is generated, and one of the generative AI conversational agent and the rule-based AI conversational agent is updated based upon the feedback analysis.

### BACKGROUND

The present invention relates to conversational artificial intelligence (AI) systems, and more specifically, a hybrid conversational system that employs both rule-based and generative AI models.

Conversational AI has emerged as a critical technology for various applications including customer service, healthcare, and personal assistants. However, two primary challenges persist in this domain: the ability to maintain high-quality, contextually-relevant interactions and the need for computational cost-efficiency. Current solutions often deploy either rules-based AI models or generative AI models.

Advantages of rule-based AI systems are that they are computational efficient—both in terms of processing requirements and speed of response. Additionally, they provide repeatable answers given the same inputs. However, rule-based AI systems operate within the confines of the rules programmed therein, and consequently, they lack the flexibility to handle inputs for which rules have not been generated. Additionally, the response provided by a rule-based AI system to a particular input is only as good as the original rule created for the input. Still further, while rule-based AI systems can be modified, these modifications are generally time-consuming.

Generative AI systems, which are an offshoot of machine learning systems, can be trained to handle complex, context-sensitive dialogues. As generative AI is based upon machine learning, these systems have the capability for self-learning, in which the model can improve over time. One disadvantage of generative AI is that these systems oftentimes require significant computational resources. Additionally, generative AI is known to “hallucinate,” which refers to the possibility of generative AI creating wrong answers to particular inputs. Generative AI can also be inconsistent—providing different answers to the same input, which can be undesirable.

### SUMMARY

A method is performed by a computer hardware system including a hybrid router/manager, a generative artificial intelligence (AI) conversational agent, a rule-based AI conversational agent, and a content store. A present query is received from a client device associated with a user. The hybrid router/manager selects between the generative AI conversational agent and the rule-based AI conversational agent based upon a query analysis of the present query. The hybrid router/manager, based upon the query analysis, routes the present query to a selected one of the generative AI conversational agent and the rule-based AI conversational agent. The selected one of the generative AI conversational agent and the rule-based AI conversational agent generates a response to the present query, and the response is forwarded to the client device associated with the user. A feedback analysis associated with the response is generated, and one of the generative AI conversational agent and the rule-based AI conversational agent is updated based upon the feedback analysis.

Additionally, the methodology includes the generative AI conversational agent being selected to generate the response, and the updating includes updating a ruleset within the rule-based AI conversational agent based upon the response and configuring the hybrid router/manager to forward queries similar to the present query to the rule-based AI conversational agent. Also, the updating can include updating training data for the generative AI conversational agent. The contextual store includes context information for the present query, and the context information for the present query includes information regarding a least one prior query and at least one prior response in a conversation to which the query is associated. The conversation includes a first reply from the generative AI conversational agent and a second reply from the rule-based AI conversational agent. The feedback analysis can be based upon explicit feedback provided by the user and/or inferred feedback based upon an analysis of an interaction of the user with the computer hardware system.

A computer hardware system includes a hybrid router/manager, a generative artificial intelligence (AI) conversational agent, a rule-based AI conversational agent, and a content store. The computer hardware fuzzy logic system includes a hardware processor configured to initiate the following operations. A present query is received from a client device associated with a user. The hybrid router/manager selects between the generative AI conversational agent and the rule-based AI conversational agent based upon a query analysis of the present query. The hybrid router/manager, based upon the query analysis, routes the present query to a selected one of the generative AI conversational agent and the rule-based AI conversational agent. The selected one of the generative AI conversational agent and the rule-based AI conversational agent generates a response to the present query, and the response is forwarded to the client device associated with the user. A feedback analysis associated with the response is generated, and one of the generative AI conversational agent and the rule-based AI conversational agent is updated based upon the feedback analysis.

Additionally, the system includes the generative AI conversational agent being selected to generate the response, and the updating includes updating a ruleset within the rule-based AI conversational agent based upon the response and configuring the hybrid router/manager to forward queries similar to the present query to the rule-based AI conversational agent. Also, the updating can include updating training data for the generative AI conversational agent. The contextual store includes context information for the present query, and the context information for the present query includes information regarding a least one prior query and at least one prior response in a conversation to which the query is associated. The conversation includes a first reply from the generative AI conversational agent and a second reply from the rule-based AI conversational agent. The feedback analysis can be based upon explicit feedback provided by the user and/or inferred feedback based upon an analysis of an interaction of the user with the computer hardware system.

A computer program product comprises a computer readable storage medium having stored therein program code. The program code, which when executed by a computer hardware system including a hybrid router/manager, a generative artificial intelligence (AI) conversational agent, a rule-based AI conversational agent, and a content store, causes the computer hardware system to perform the following. A present query is received from a client device associated with a user. The hybrid router/manager selects between the generative AI conversational agent and the rule-based AI conversational agent based upon a query analysis of the present query. The hybrid router/manager, based upon the query analysis, routes the present query to a selected one of the generative AI conversational agent and the rule-based AI conversational agent. The selected one of the generative AI conversational agent and the rule-based AI conversational agent generates a response to the present query, and the response is forwarded to the client device associated with the user. A feedback analysis associated with the response is generated, and one of the generative AI conversational agent and the rule-based AI conversational agent is updated based upon the feedback analysis.

Additionally, the compute program product includes the generative AI conversational agent being selected to generate the response, and the updating includes updating a ruleset within the rule-based AI conversational agent based upon the response and configuring the hybrid router/manager to forward queries similar to the present query to the rule-based AI conversational agent. Also, the updating can include updating training data for the generative AI conversational agent. The contextual store includes context information for the present query, and the context information for the present query includes information regarding a least one prior query and at least one prior response in a conversation to which the query is associated. The conversation includes a first reply from the generative AI conversational agent and a second reply from the rule-based AI conversational agent. The feedback analysis can be based upon explicit feedback provided by the user and/or inferred feedback based upon an analysis of an interaction of the user with the computer hardware system.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a hybrid conversational AI system according to an embodiment of the present invention.

FIG. 2 is a block diagram illustrating a methodology of generating a response to a query using the architecture of FIG. 1 upon the query being routed a rule-based AI conversational agent according to an embodiment of the present invention.

FIG. 3 is a block diagram illustrating a methodology of generating a response to a query using the architecture of FIG. 1 upon the query being routed a generative AI conversational agent according to an embodiment of the present invention.

FIG. 4 is a block diagram illustrating an example of a computer environment for implementing portions of the methodology of FIG. 2.

### DETAILED DESCRIPTION

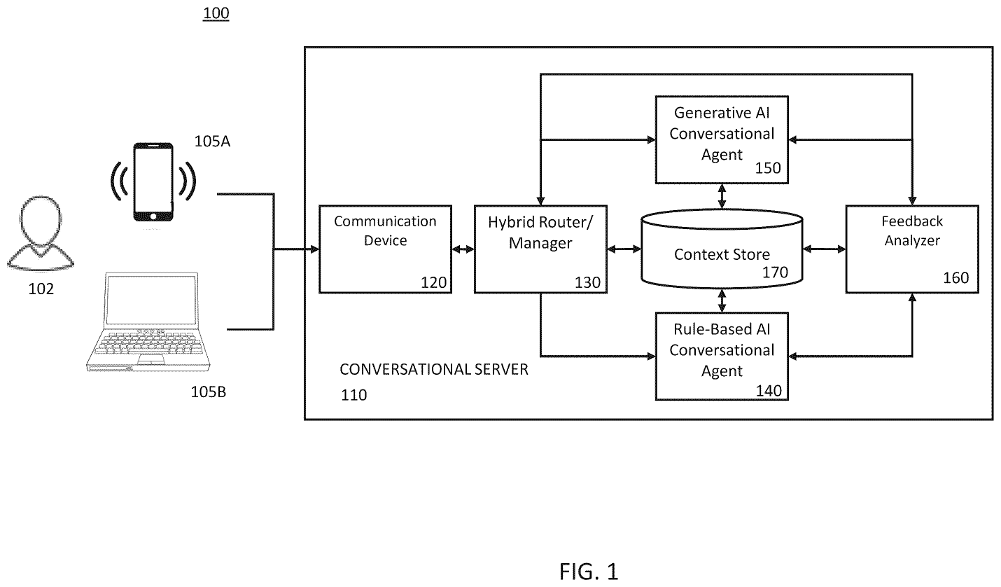

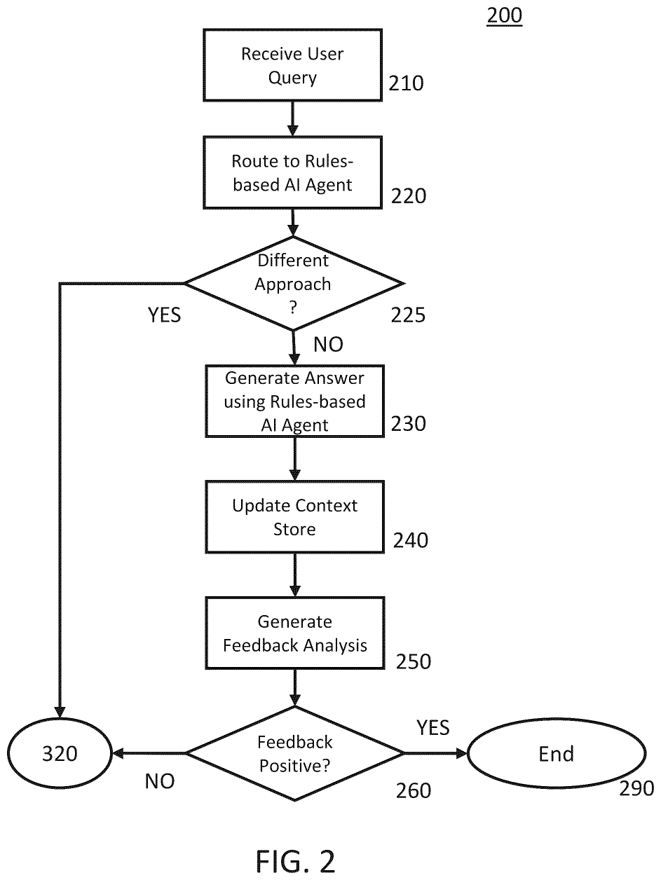

Referring to FIGS. 1 and 2, an exemplary hybrid conversational artificial intelligence (AI) system 100 and methodologies 200 and 300 of using the same are illustrated. In certain aspects, the hybrid conversational AI system 100 includes a hybrid router/manager 130, a generative artificial intelligence (AI) conversational agent 150, a rule-based AI conversational agent 140, and a content store 170. In operation, a present query is received from a client device 105A-B associated with a user 102. The hybrid router/manager 130 selects between the generative AI conversational agent 150 and the rule-based AI conversational agent 140 based upon a query analysis of the present query. The hybrid router/manager 130, based upon the query analysis, routes the present query to a selected one of the generative AI conversational agent 150 and the rule-based AI conversational agent 140. The selected one of the generative AI conversational agent 150 and the rule-based AI conversational agent 140 then generates a response to the present query, and the response is forwarded to the client device 105A-B associated with the user 102. A feedback analysis associated with the response is generated using a feedback analyzer 160, and at least one of the generative AI conversational agent 150 and the rule-based AI conversational agent 140 is updated based upon the feedback analysis. In an instance in which the generative AI conversational agent 150 was selected to generate the response, and the updating includes updating a ruleset within the rule-based AI conversational agent 140 based upon the response and configuring the hybrid router/manager 130 to forward queries similar to the present query to the rule-based AI conversational agent 140. Also, the updating can include updating training data for the generative AI conversational agent 150.

The hybrid conversational AI system 100 improves over prior systems by optimizing computation cost by reducing redundant queries to the generative AI conversational agent 150 thereby saving on operational expenses. Additionally, the hybrid conversational AI system can maintain a high level of interaction quality by utilizing the generative AI conversational agent 150 for complex, context-sensitive dialogues. The feedback analysis also permits dynamic learning capability in which the rule-based AI conversational agent 140 can be updated based upon successful generative AI interactions.

More specifically, the hybrid conversational AI system 100 includes a conversational server 110 having a number of components including a communication device 120, hybrid router/manager 130, rule-based artificial intelligence (AI) conversational agent 140, generative AI conversational agent 150, feedback analyzer 160, and context store 170. Although these components are illustrated as being separate components, one or more of these components can be integrated together and/or divided into separate components and/or provided as software as a service, as further described with regard to FIG. 5.

In general, the hybrid router/manager 130 controls the flow of queries between the rule-based AI conversational agent 140 and the generative AI conversational agent 150. The rule-based AI conversational agent 140 is configured to handle common queries with pre-defined rules. The generative AI conversational agent 150 is configured to handle complex, context-sensitive queries. The feedback analyzer 160 is configured to monitor the effectiveness of the conversational server 110 and guides improvements for the same. The context store 170 is configured to act as a repository for shared context between the two conversational agents 140, 150. The following is a more detailed discussion of these components 130, 140, 150, 160, 170.

### Rule-Based AI Conversational Agent

The rule-based AI conversational agent 140 is not limited as to a particular type and/or configuration, and this type of AI conversational agent is a known technology. The rule-based AI conversational agent 140 is configured to swiftly respond to predefined queries using a set of pre-programmed rules. Using, for example, a decision tree or state machine architecture, the rule-based AI conversational agent 140 is configured to cover a broad spectrum of frequent queries. Upon a query being routed to the rule-based AI conversational agent 140, the query is matched against an existing set of rules within the rule-based AI conversational agent 140 to generate an appropriate response. The rule-based AI conversational agent 140 can also use contextual information stored within the context capture store 170 when generating the response. An illustrative example of such an agent is IBM's Watson Assistant.

### Generative AI Conversational Agent

The generative AI conversational agent 150 is not limited as to a particular type and/or configuration, and this type of AI conversational agent is a known technology. The generative AI conversational agent 150 is configured to handle queries that are complex and context-sensitive. The generative AI conversational agent 150 is configured to use machine learning algorithms to generate responses that are not predefined but rather constructed on-the-fly (i.e., dynamically) based on the input (i.e., the query). The generative AI conversational agent 150 can also use contextual information stored within the context capture store 170 when generating the response.

A generative AI is a particular type of neural model typically employing a Large Language Model (LLM). LLMs are a class of foundation models, which is a type of large-scale, general purpose AI model that can be adapted to perform a variety of different activities. Foundation models are typically trained on large amounts of generalized and unlabeled data to provide the foundational capabilities needed to supply multiple use cases and applications, as well as resolve a multitude of tasks. In the past, LLMs have been used for natural-language processing, but they can also be used, among other things, to generate answers in response to user inputs (prompts). Illustrative examples of such LLMs include Llama2 by Meta, GPT by OpenAI, and Granite by IBM.

### Hybrid Router/Manager

The hybrid router/manager 130 is a specialized device that is configured to control and optimize the flow of queries routed between the rule-based AI conversational agent 140 and the generative AI conversational agent 150. The optimization is for providing both computational efficiency and high-quality responses to the user 102 that provides a query. Although not limited in this manner, the hybrid router/manager 130 can be configured to perform an initial query analysis of the incoming query to determine aspects of the query including: complexity, length, keyword density among other heuristics.

Using a query analysis based upon a heuristic rule set or a machine learning model specifically trained for this purpose, the hybrid router/manager 130 makes a selection between the rule-based AI conversational agent 140 or the generative AI conversational agent 150. The query analysis can take into account factors such as complexity of the query, historical performance data for similar queries, current system load, and availability of relevant context in the context store 170. After the selection has been made, the hybrid router/monitor 130 is configured to forward the query to either the rule-based AI conversational agent 140 or the generative AI conversational agent 150.

After the response has been generated by either the rule-based AI conversational agent 140 or the generative AI conversational agent 150 and subsequently provided to the user 102, the hybrid router/manager 130 is configured to receive a feedback analysis provided by the feedback analyzer 160. The feedback analysis can include data such as perceived quality of the response and performance data, e.g., response time (e.g., a time between when the query was forwarded to the selected agent 140, 150 and a time when the response was created by the selected agent 140, 150). The results of the feedback analysis can be stored, e.g., within the context store 170, and subsequently used by the hybrid route/manager 130 to select either the rule-based AI conversational agent 140 or the generative AI conversational agent 150.

### Feedback Analyzer

The feedback analyzer 160 is configured to collect and analyze feedback on the effectiveness of responses generated by both the rule-based AI conversational agent 140 and the generative AI conversational agent 150. The manner in which the feedback is gathered and analyzed is not limited as to a particular approach. In certain aspects, the feedback analyzer 160 may cause a prompt to be sent to the user 102 asking for input regarding the answer. This prompt could, for example, ask the user to respond with a natural language response and/or provide a rating.

Additionally and/or alternatively, the feedback analyzer 160 can be configured to infer feedback from actions of the user 102. For example, if a user 105 continues to interact with the hybrid conversational AI system 100 after receiving a response, the feedback analyzer 160 may treat this as an implicit sign that the response was satisfactory. Alternatively, if the user 105 repeats the question, the feedback analyzer 160 may treat this as an implicit sign that the response was unsatisfactory. The feedback, whether explicit and/or inferred, can be then aggregated by the feedback analyzer in a structured format as part of the feedback analysis.

The feedback analyzer 160 can be configured to collect and/or generate various metrics such as user interaction rate, interaction depth (e.g., how many turns in the conversation), and time-to-resolution among others. Additional, the feedback analyzer 160 can employ natural language processing (NLP) and/or sentimental analysis to obtain additional insights from the user 102 to be included within the feedback analysis.

Using the feedback analysis, the feedback analyzer 160 can interact with the hybrid router/manager 130, the rule-based AI conversational agent 140, and the generative AI conversational agent 150 to make modifications thereto. For example, the feedback analyzer 160 can provide recommendations to make changes to how future queries are routed by the hybrid router/manager 130. For instance, if a determination is made that the rule-based AI conversational agent 140 provides a response that receives poor feedback, the recommendation can be to forward future similar queries to the generative AI conversational agent 150. As another example, the feedback analyzer 160 can provide recommendations for updating rules within the rule-based AI conversational agent 140. Also, the feedback analyzer 160 can provide recommendations for updating the training data for the generative AI conversational agent 150.

In certain aspects of the conversational server 110, these recommendations can be implemented automatically. Additionally, the feedback analyzer 160 can be configured to monitor how those changes impact key performance indicators such as interaction rate, interaction depth, and time-to-resolution. The feedback analyzer 160 can also be configured to identify trends/patterns in user behavior and/or system performance with this information being used to provide actionable insights for long-term improvements to the conversational server 110. By incorporating these functionalities, the feedback analyzer 160 actively contributes to the ongoing refinement and effectiveness of the hybrid conversational AI system 100, thereby enhancing user experience and system accuracy.

### Context Store

The context store 170 is configured to serve as a repository for contextual information that can be shared between the rule-based AI conversational agent 140, and the generative AI conversational agent 150. As a conversation between the user 102 and the conversational server 110 progresses, queries by the user 102 can be routed to both the rule-based AI conversational agent 140 and the generative AI conversational agent 150. In a traditional system in which only a single agent is used, that single agent will be able to store/use past contextual data in formulating new responses. However, that will not be true when multiple different agents are interacting with the same user 102 over the course of a single interaction. By providing a mechanism to maintain a context that is shared between the rule-based AI conversational agent 140 and the generative AI conversational agent 150, the conversational server 110 can deliver more accurate and relevant responses over the course of an interaction with the user 102.

In certain aspects, the context store 170 is configured to support real-time updates that allows either agent 140, 150 to modify or append new contextual data as interactions evolve. In other aspects, certain contextual data can have an expiry time after which it is considered stale and is removed or updated.

As used herein, the term “context” refers to information regarding both the queries (from the user 102) and responses (by the conversational server 110) within a single interaction. Contextual information can also refer to topic of conversation, user preferences, or any other state variables. Context can also refer to information gathered by either agent 140, 150 that is subsequently used to formulate a response. This context can then be stored in a structured formation within the context store 170.

In operation, when either the rule-based AI conversational agent 140 or the generative AI conversational agent 150, either agent 140, 150 can retrieve contextual information from the context store 170. In an alternative aspect, the hybrid router/manager 130 can retrieve this contextual information in response to receiving a new query and provide this contextual information when routing the new query to either the rule-based AI conversational agent 140 or the generative AI conversational agent 150. Additionally, the context store 170 can be configured to support inter-agent communication in which the context store 170 can pass specific directives or flags to from one agent 140, 150 to another agent 150, 140 thereby coordinating their behavior. For example, if the rule-based AI conversational agent 140 encounters a complex query that it cannot handle, the rule-based AI conversational agent 140 may set a flag in the context store 170 that directs the generative AI conversational agent 150 to take over the processing of generating a response to the complex query.

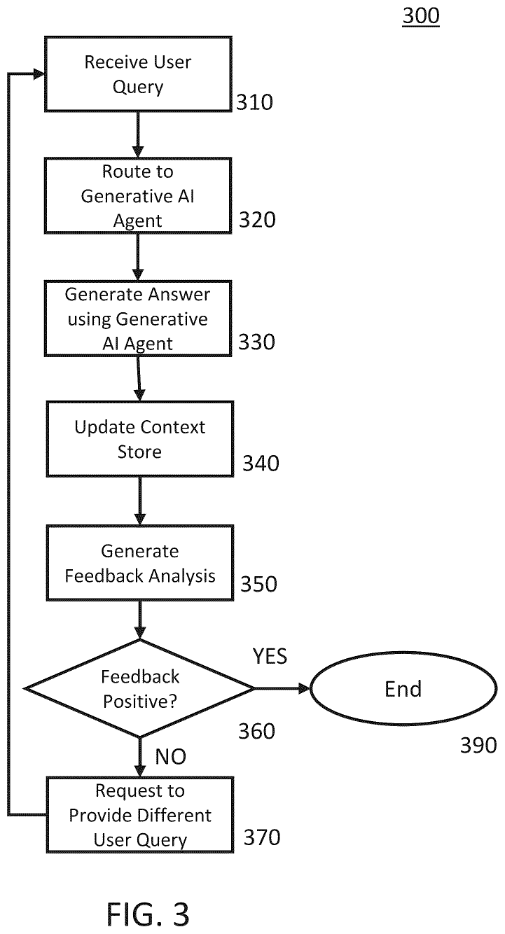

With specific reference to FIGS. 2 and 3, an overview of the general processes 200, 300 for employing the hybrid conversational AI system 100 is disclosed. FIG. 2 illustrates the process 200 in which the hybrid router/manager 130 routes the query to the rule-based AI conversational agent 140 and FIG. 3 illustrates the process 300 in which the hybrid router/manager 130 routes the query to the generative AI conversational agent 150.

In 210, a user input (also referred to herein as a “query”) from a user device 105A-B associated with a user 102 is received by the conversational server 110 via the communication device 120. The manner in which the conversational server 110 receives the user input is not limited as to any approach, previously known or otherwise. The user input can be the start of a new interaction between the user 102 and the conversational server 110 or part of an ongoing interaction between the user 102 and the conversational server 110. Known technology can be employed to determine whether the query is the start of a new interaction or part of an ongoing interaction.

In 220, the hybrid router/manager 130 makes a determination as to whether to route the query to either the rule-based AI conversational agent 140 or the generative AI conversational agent 150. In so doing, the hybrid router/manager 130 performs an initial query analysis on the incoming query and makes a routing decision/selection using a set of heuristic criteria. In FIG. 2, the routing decision/selection involves routing the query to the rule-based AI conversational agent 140.

In 225, the rule-based AI conversational agent 140 may make an initial determination that a response cannot be satisfactorily generated for the query. If so, the query is routed to the generative AI conversational agent 150 in 320 (FIG. 3). Otherwise, in 230, the rule-based AI conversational agent 140 is configured to generate a response that is subsequently forwarded to the user 102 via the communication device 120. At or around the same time, in 240, the rule-based AI conversational agent 140 is configured to store contextual information regarding the query being responded to as well as the response within the context store 170.

In 250, the feedback analyzer 160 is configured to generate a feedback analysis based upon the response that was provided to the user 102. As discussed above, the feedback analyzer 160 can use explicit and/or inferred feedback to generate the feedback analysis and this feedback analysis can subsequently be used to generate recommendations (i.e., dynamic learning) for updating rules within the rule-based AI conversational agent 140.

In 260, in certain instances a determination can be made, using the feedback analysis, that the response was insufficient. In such an instance, the query can be routed to the generative AI conversational agent 150 in 320 (FIG. 3). Otherwise, in 290, the process 200 ends until another user query is received.

Referring to FIG. 3, in 310, a user input from a user device 105A-B associated with a user 102 is received by the conversational server 110 via the communication device 120. The manner in which the conversational server 110 receives the user input is not limited as to any approach, previously known or otherwise. The user input can be the start of a new interaction between the user 102 and the conversational server 110 or part of an ongoing interaction between the user 102 and the conversational server 110. Known technology can be employed to determine whether the query is the start of a new interaction or part of an ongoing interaction.

In 320, the hybrid router/manager 130 makes a determination as to whether to route the query to either the rule-based AI conversational agent 140 or the generative AI conversational agent 150. In so doing, the hybrid router/manager 130 performs an initial query analysis on the incoming query and makes a routing decision/selection using a set of heuristic criteria. In FIG. 3, the routing decision/selection involves routing the query to the generative AI conversational agent 150.

In 330, the generative AI conversational agent 150 is configured to generate a response that is subsequently forwarded to the user 102 via the communication device 120. At or around the same time, in 340, the generative AI conversational agent 150 is configured to store contextual information regarding the query being responded to as well as the response within the context store 170.

In 350, the feedback analyzer 160 is configured to generate a feedback analysis based upon the response that was provided to the user 102. As discussed above, the feedback analyzer 160 can use explicit and/or inferred feedback to generate the feedback analysis and this feedback analysis can subsequently be used to generate recommendations (i.e., dynamic learning) for updating the training data for the generative AI conversational agent 150.

In 360, in certain instances a determination can be made, using the feedback analysis, that the response was insufficient. In such an instance, a request can be made to the user to ask provide a different user query (e.g., ask to “rephrase the question”). Alternatively, the request can be resubmitted to the generative AI conversational agent 150. Otherwise, in 390, the process 300 ends until another user query is received.

As defined herein, the term “responsive to” means responding or reacting readily to an action or event. Thus, if a second action is performed “responsive to” a first action, there is a causal relationship between an occurrence of the first action and an occurrence of the second action, and the term “responsive to”indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically”means without user intervention.

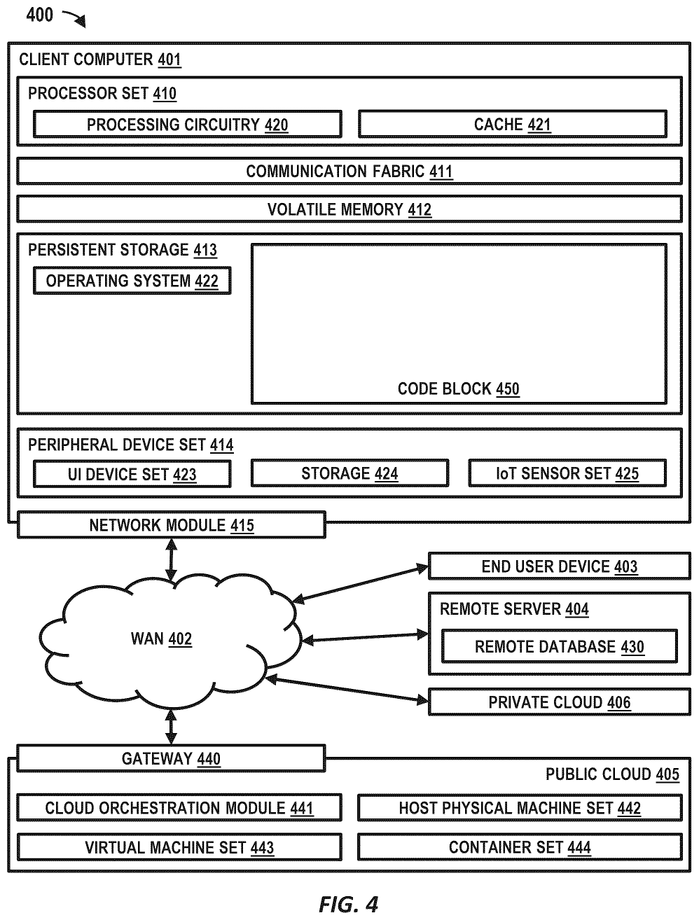

Referring to FIG. 4, computing environment 400 contains an example of an environment for the execution of at least some of the computer code involved in performing the inventive methods, such as code block 450 for implementing the operations of the conversational server 110. Computing environment 400 includes, for example, computer 401, wide area network (WAN) 402, end user device (EUD) 403, remote server 404, public cloud 405, and private cloud 406. In certain aspects, computer 401 includes processor set 410 (including processing circuitry 420 and cache 421), communication fabric 411, volatile memory 412, persistent storage 413 (including operating system 422 and method code block 450), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. However, to simplify this presentation of computing environment 400, detailed discussion is focused on a single computer, specifically computer 401. Computer 401 may or may not be located in a cloud, even though it is not shown in a cloud in FIG. 4 except to any extent as may be affirmatively indicated.

Processor set 410 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In certain computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code block 450 in persistent storage 413.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 411 is the signal conduction paths that allow the various components of computer 401 to communicate with each other. Typically, this communication fabric 411 is made of switches and electrically conductive paths, such as the switches and electrically conductive paths that make up busses, bridges, physical input/output ports and the like. Other types of signal communication paths may be used for the communication fabric 411, such as fiber optic communication paths and/or wireless communication paths.

Volatile memory 412 is any type of volatile memory now known or to be developed in the future. Examples include dynamic type random access memory (RAM) or static type RAM. Typically, the volatile memory 412 is characterized by random access, but this is not required unless affirmatively indicated. In computer 401, the volatile memory 412 is located in a single package and is internal to computer 401. In addition to alternatively, the volatile memory 412 may be distributed over multiple packages and/or located externally with respect to computer 401.

Persistent storage 413 is any form of non-volatile storage for computers that is now known or to be developed in the future. The non-volatility of the persistent storage 413 means that the stored data is maintained regardless of whether power is being supplied to computer 401 and/or directly to persistent storage 413. Persistent storage 413 may be a read only memory (ROM), but typically at least a portion of the persistent storage 413 allows writing of data, deletion of data and re-writing of data. Some familiar forms of persistent storage 413 include magnetic disks and solid state storage devices. Operating system 422 may take several forms, such as various known proprietary operating systems or open source Portable Operating System Interface type operating systems that employ a kernel. The code included in code block 450 typically includes at least some of the computer code involved in performing the inventive methods.

Peripheral device set 414 includes the set of peripheral devices for computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some aspects, storage 424 may take the form of a quantum computing storage device for storing data in the form of qubits. In aspects where computer 401 is required to have a large amount of storage (for example, where computer 401 locally stores and manages a large database) then this storage 424 may be provided by peripheral storage devices designed for storing very large amounts of data, such as a storage area network (SAN) that is shared by multiple, geographically distributed computers. Internet-of-Things (IoT) sensor set 425 is made up of sensors that can be used in IoT applications. For example, one sensor may be a thermometer and another sensor may be a motion detector.

Network module 415 is the collection of computer software, hardware, and firmware that allows computer 401 to communicate with other computers through a Wide Area Network (WAN) 402. Network module 415 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 415 are performed on the same physical hardware device. In other aspects (for example, aspects that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any Wide Area Network (for example, the internet) capable of communicating computer data over non-local distances by any technology for communicating computer data, now known or to be developed in the future. In some aspects, the WAN 402 ay be replaced and/or supplemented by local area networks (LANs) designed to communicate data between devices located in a local area, such as a Wi-Fi network. The WAN 402 and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In certain aspects, EUD 403 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404. As defined herein, the term “server” means a data processing system configured to share services with one or more other data processing systems.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other aspects, a private cloud 406 may be disconnected from the internet entirely (e.g., WAN 402) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 405 and private cloud 406 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method by a computer hardware system including a hybrid router/manager, a generative artificial intelligence (AI) conversational agent, a rule-based AI conversational agent, and a content store, comprising:
receiving, from a client device associated with a user, a present query;
selecting, by the hybrid router/manager and based upon a query analysis of the present query, between the generative AI conversational agent and the rule-based AI conversational agent;
routing, by the hybrid router/manager and based upon the query analysis, the present query to a selected one of the generative AI conversational agent and the rule-based AI conversational agent;
generating, by the selected one of the generative AI conversational agent and the rule-based AI conversational agent, a response to the present query;
forwarding the response to the client device associated with the user;
generating a feedback analysis associated with the response; and
updating one of the generative AI conversational agent and the rule-based AI conversational agent based upon the feedback analysis.

2. The method of claim 1, wherein
the generative AI conversational agent was selected to generate the response, and
the updating includes updating a ruleset within the rule-based AI conversational agent based upon the response.

3. The method of claim 2, wherein
the updating includes configuring the hybrid router/manager to forward queries similar to the present query to the rule-based AI conversational agent.

4. The method of claim 1, wherein
the updating includes updating training data for the generative AI conversational agent.

5. The method of claim 1, wherein
the contextual store includes context information for the present query.

6. The method of claim 5, wherein
the context information for the present query includes information regarding a least one prior query and at least one prior response in a conversation to which the query is associated.

7. The method of claim 6, wherein
the conversation includes a first reply from the generative AI conversational agent and a second reply from the rule-based AI conversational agent.

8. The method of claim 1, wherein
the feedback analysis is based upon explicit feedback provided by the user.

9. The method of claim 1, wherein
the feedback analysis is based upon inferred feedback based upon an analysis of an interaction of the user with the computer hardware system.

10. A computer hardware system including a hybrid router/manager, a generative artificial intelligence (AI) conversational agent, a rule-based AI conversational agent, and a content store, comprising:
a hardware processor configured to initiate the following executable operations:
receiving, from a client device associated with a user, a present query;
selecting, by the hybrid router/manager and based upon a query analysis of the present query, between the generative AI conversational agent and the rule-based AI conversational agent;
routing, by the hybrid router/manager and based upon the query analysis, the present query to a selected one of the generative AI conversational agent and the rule-based AI conversational agent;
generating, by the selected one of the generative AI conversational agent and the rule-based AI conversational agent, a response to the present query;
forwarding the response to the client device associated with the user;
generating a feedback analysis associated with the response; and
updating one of the generative AI conversational agent and the rule-based AI conversational agent based upon the feedback analysis.

11. The system of claim 10, wherein
the generative AI conversational agent was selected to generate the response, and
the updating includes updating a ruleset within the rule-based AI conversational agent based upon the response.

12. The system of claim 11, wherein
the updating includes configuring the hybrid router/manager to forward queries similar to the present query to the rule-based AI conversational agent.

13. The system of claim 10, wherein
the updating includes updating training data for the generative AI conversational agent.

14. The system of claim 10, wherein
the contextual store includes context information for the present query.

15. The system of claim 14, wherein
the context information for the present query includes information regarding a least one prior query and at least one prior response in a conversation to which the query is associated.

16. The system of claim 15, wherein
the conversation includes a first reply from the generative AI conversational agent and a second reply from the rule-based AI conversational agent.

17. The system of claim 10, wherein
the feedback analysis is based upon explicit feedback provided by the user.

18. The system of claim 10, wherein
the feedback analysis is based upon inferred feedback based upon an analysis of an interaction of the user with the computer hardware system.

19. A computer program product, comprising:
a computer readable storage medium having stored therein program code,
the program code, which when executed by a computer hardware system including a hybrid router/manager, a generative artificial intelligence (AI) conversational agent, a rule-based AI conversational agent, and a content store, causes the computer hardware system to perform:
receiving, from a client device associated with a user, a present query;
selecting, by the hybrid router/manager and based upon a query analysis of the present query, between the generative AI conversational agent and the rule-based AI conversational agent;
routing, by the hybrid router/manager and based upon the query analysis, the present query to a selected one of the generative AI conversational agent and the rule-based AI conversational agent;
generating, by the selected one of the generative AI conversational agent and the rule-based AI conversational agent, a response to the present query;
forwarding the response to the client device associated with the user;
generating a feedback analysis associated with the response; and
updating one of the generative AI conversational agent and the rule-based AI conversational agent based upon the feedback analysis.

20. The computer program product of claim 10, wherein
the generative AI conversational agent was selected to generate the response,
the updating includes updating a ruleset within the rule-based AI conversational agent based upon the response, and
the updating includes configuring the hybrid router/manager to forward queries similar to the present query to the rule-based AI conversational agent.
